(19) United States
(12) Patent Application Publication
(10) Pub. No.: US 2016/0347975 A1
(43) Pub. Date: Dec. 1, 2016

(54) DUAL-PACK ADHESIVE AND STRUCTURAL PIECE CONTAINING SAME

(71) Applicant: 3M INNOVATIVE PROPERTIES COMPANY, Saint Paul, MN (US)

(72) Inventor: Shinichi Irie, Tokyo (JP)

(21) Appl. No.: 15/117,534

(22) PCT Filed: Feb. 17, 2015
(86) PCT No.: PCT/US15/16090

§ 371 Date: Aug. 9, 2016

(30) Foreign Application Priority Data
Feb. 21, 2014 (JP) 2014-032239

(51) Int. Cl. C09J 133/10; B32B 7/12; B32B 27/32; C09J 133/14; C09J 7/02

(52) U.S. Cl. CPC C09J 133/10; C09J 133/14; C09J 7/0271; B32B 27/32; B32B 7/12; C09J 2423/006; B32B 2305/72

(57) ABSTRACT

An adhesive that exhibits superior adhesive strength on adhesive-resistant materials such as olefin elastomer substrates when cured at a comparatively high temperature of 35° C., and that is hot water resistant. A two-pack adhesive comprising (A) a primary agent containing (1) isobornyl methacrylate and (2) at least one type of monocyclic methacrylate selected from a group including phenoxyethyl methacrylate, tetrahydrofurfuryl methacrylate, and cyclohexyl methacrylate, and (B) an initiator containing an organoborane, with the adhesive containing from 40 to 200 parts by mass of the monocyclic methacrylate per 100 parts by mass isobornyl methacrylate.

### FIELD OF THE INVENTION

The present disclosure relates to a two-pack adhesive and a structural piece containing the same, and, in particular, to a reactive two-pack adhesive for a low surface energy substrate and a structural piece containing the adhesive.

### BACKGROUND ART

Low surface energy plastic substrates such as polyethylene (PE), polypropylene (PP), and polytetrafluoroethylene (PTFE) require an efficient and effective means for bonding using an adhesive. It is well known that these substrates have adhesive-resistant properties.

To bond these adhesive-resistant substrates, it is often necessary to perform a surf ace treatment such as name treatment, ITRO treatment, corona discharge, plasma treatment, ozone- or oxidative acid-induced oxide, sputter etching, or the like. A primer containing a high surface energy material may be used to coat the surface of an adhesive-resistant substrate, but one of the abovementioned surface treatments may be necessary in order to deposit a sufficient amount of primer. Thus, complicated and costly treatments are often necessary in order to bond an adhesive-resistant substrate, and sufficient adhesive strength may not be obtained even if such a treatment is performed.

A reactive two-pack adhesive constituted by an initiator (curing agent) containing an organoborane, which is an aerobic initiator that acts in the presence of air or oxygen, and a primary agent containing a (meth)acrylic monomer is known to exhibit superior adhesive strength on adhesive-resistant substrates such as polypropylene.

PCT Application No. 2002-517594 discloses a “polymerizable composition that contains a monomer blend containing a first ethylenically unsaturated monomer and a second ethylenically unsaturated monomer, and that is for use with an aerobic initiator, the monomer blend having an average boiling point of at least about 160° C. and an average monomer fluorophilicity of at least 3.25, and being capable of forming a polymer having a glass transition temperature of about −20° C. when polymerized”.

PCT Application No. 2005-514489 discloses an “adhesive composition containing (i) an organic borane, (ii) at least one type of polymerizable monomer, and (iii) a metal salt represented by the formula [M⁸⁺Ln][X^{-m}]_{a/m} (1), wherein M is a metal cation having two chemically usable oxidation states and a positive charge a, a is an integer from 1 to 6, X is a counterion having a charge of −m, m is an integer from 1 to 3, L is a ligand having a covalent bond, and n is an integer from 0 to 10 and expresses the number of ligands covalently bonded with the metal cations”,

### SUMMARY OF THE INVENTION

Lightweight, economical, and non-toxic polyolefin resins, especially polypropylene resins, are used in automotive applications. Adhesives used with automobile exterior parts containing such resins must have high weather resistance, such as water resistance at comparatively high temperatures. For structural elements for which properties such as strength and impact resistance are required, such as door modules and bumpers, polypropylene blended with or modified by an elastomer (high-impact polypropylene) is often used. It is known that (meth)acrylic adhesives easily penetrate elastomers; however, it has been found that when a (meth)acrylic adhesive utilizing an aerobic initiator is applied to an olefin elastomer substrate of this sort, oxygen adsorbed by the elastomer, along with atmospheric oxygen, produces large quantities of activated aerobic initiator species during the initial stages of polymerization. As a result, the polymerization level of the obtained polymer is reduced, potentially preventing the level of cohesive strength necessary for bonding from being obtained.

In addition, large quantities of activated aerobic initiator species are also produced during the initial stages of polymerization when a (meth)acrylic adhesive utilizing an aerobic initiator is cured at a comparatively high ambient temperature, such as around 35° C., a temperature often encountered in summer, similarly preventing sufficient adhesive strength from being obtained.

The present disclosure provides an adhesive that exhibits superior adhesive strength on adhesive-resistant materials such as olefin elastomer substrates when cured at the comparatively high temperature of 35° C., and is not water resistant, that is, it can maintain adhesive strength even after being left for 168 hours in 70° C. water, for example.

In one aspect of the present invention, a two-pack adhesive is provided that comprises (A) a primary agent containing (1) isobornyl methacrylate and (2) at least one type of monocyclic methacrylate selected from a group consisting of phenoxyethyl methacrylate tetrahydrofurfuryl methacrylate, and cyclohexyl methacrylate, and (B) an initiator containing an organoborane. The adhesive contains from 40 to 200 parts by mass of the monocyclic methacrylate per 100 parts by mass isobornyl methacrylate.

In another aspect of the present invention, a structural piece is provided that has a first olefin elastomer substrate, a second olefin elastomer substrate, and a cured product of the two-pack adhesive disposed between the first olefin elastomer substrate and the second olefin elastomer substrate, thereby bonding the first olefin elastomer substrate and the second olefin elastomer substrate.

In accordance with the present invention, a two-pack adhesive can be obtained that exhibits superior adhesive strength on adhesive-resistant materials such as polymer blends of elastomers and polypropylene or elastomer-modified polypropylene even when cured at a comparatively high temperature of 135° C. and is hot water resistant, namely, a can maintain adhesive strength even after being left for 168 hours in 70° C. water for example.

The above descriptions should not be construed as disclosing all of the embodiments and benefits of the present invention.

### BRIEF DESCRIPTION OF THE DRAWINGS

FIG. 1 is a cross-sectional view of a structural piece according to an embodiment of the present disclosure,

### DETAILED EMBODIMENTS OF THE PRESENT INVENTION

The following is a detailed description for the purpose of illustrating representative embodiments of the present invention, but these embodiments should not be construed as limiting the present invention.

In the present disclosure, the term “(meth)acrylic” means “acrylic” or “methacrylic”, and the term “(meth)acrylate” means “acrylate” or “methacrylate”.

In the present disclosure, the term “polymerizable component” means another (meth)acrylic monomer or oligomer, another polymerizable monomer or oligomer, or another component that is capable of reacting or polymerizing with the isobornyl methacrylate and the monocyclic methacrylate included, as necessary, in the primary agent (A) and/or the initiator (B) in addition to the isobornyl methacrylate and the monocyclic methacrylate contained in the primary agent (A). When the term “polymerizable component” is used in relation to parts by mass, the total mass of the component(s) is indicated.

A two-pack adhesive according to one embodiment of the present disclosure is constituted by (A) the primary agent and (B) the initiator. The primary agent contains (1) isobornyl methacrylate and (2) at least one type of monocyclic methacrylate selected from a group consisting of phenoxyethyl methacrylate, tetrahydrofurfuryl methacrylate, and cyclohexyl methacrylate. The initiator contains an organoborane, which is an aerobic initiator. The two-pack adhesive contains about 40 to about 200 parts by mass of the monocyclic methacrylate per 100 parts by mass isobornyl methacrylate. The polymerizable component is capable of increasing the polymerization level of the polymer and imparting the adhesive cured product with the necessary cohesive strength by controlling the polymerization speed using (1) a component having a lower level of polymerization reactivity than an acrylate and (2) the methacrylate.

The isobornyl methacrylate constituting the component (1) of the primary agent (A) imparts the adhesive cured product with cohesive strength due to the high glass transition temperature (Tg) of its homopolymer. Moreover, it is believed, while not being bound by any particular theory, that, due to the comparatively low polymerization reactivity a isobornyl methacrylate, isobornyl methacrylate is not readily susceptible to the effects of oxygen adsorbed in the olefin elastomer substrate, and as a result, the polymerization level of the polymer is increased in areas near the surfaces of such substrates in which the adhesive has penetrated, thereby improving the interfacial adhesive strength of the adhesive cured product.

In some embodiments, the primary agent contains at least about 25 mass %, about 30 mass %, or about 33 mass % and no more than about 70 mass %, about 60 mass %, or about 50 mass % of isobornyl methacrylate in terms of the polymerizable component. Having the isobornyl methacrylate content fall within the abovementioned range allows the adhesive cured product to be imparted with even better adhesive strength.

The homopolymer of the monocyclic methacrylate constituting the component (2) of the primary agent has a comparatively high Tg derived from the cyclic structure, but a low Tg compared to the homopolymer of isobornyl methacrylate; this contributes to improving the brittleness of the adhesive cured product without prominently reducing the cohesive strength thereof. The monocyclic methacrylate is at least one type selected from a group consisting of phenoxyethyl methacrylate, tetrahydrofurfuryl methacrylate, and cyclohexyl methacrylate. The high boiling points of these monocyclic methacrylates make it possible to prevent or minimize odor production during work, and inhibit evaporation-induced changes in the composition of the adhesive when cured at a comparatively high temperature. Of these monocyclic methacrylates, phenoxyethyl methacrylate can be advantageously used due to its ability to impart high cohesive strength and interface adhesive strength to the adhesive cured product when combined with isobornyl methacrylate.

At least about 40 parts by mass and no more than about 200 parts by mass of the monocyclic methacrylate constituting component (2) is used per 100 parts by mass of the isobornyl methacrylate constituting component (1). In some embodiments, at least about 50 parts by mass or about 60 parts by mass to no more than about 190 parts by mass or 180 parts by mass of the monocyclic methacrylate is used per 100 parts by mass isobornyl methacrylate.

The primary agent (A) may contain other (meth)acrylic monomers or oligomers as optional ingredients. Examples of such (meth)acrylic monomers and oligomers include straight chain or branched alkyl (meth)acrylates having 1 to about 12, 1 to about 8, or 1 to about 4 carbon atoms at the alkyl site, such as methyl (meth)acrylate, ethyl (meth)acrylate, butyl (meth)acrylate, n-hexyl (meth)acrylate, 2-ethylhexyl (meth)acylate, isooctyl (meth)acrylate, and isodecyl (meth)acrylate; heteroatom-containing (meth)acrylic acid esters of monohydric alcohols, such as 2-ethoxyethyl (meth)acrylate; partial or complete esters of polyhydroxy alcohols and (meth)acrylic acid, such as ethylene glycol, diethylene glycol, polyethylene glycol, trimethylol propane, triethylene glycol, tetraethylene glycol, propylene glycol, tripropylene glycol, tetrapropylene glycol, pentapropylene glycol, polypropylene glycol, ethoxylated or propoxylated diphenylol propane, (meth)acrylic acid esters of hydroxy-terminated polyurethane, and aliphatic polyester urethane (meth)acrylates, and the like. If these (meth)acrylic monomers or oligomers are used, an amount equivalent, for example, to at least about 0.1% by mass, about 1% by mass, or about 2% by mass to no more than about 20% by mass, about 10% by mass, or about 5% by mass with respect to the polymerizable component is used. Straight-chain or branched alkyl (meth)acrylates having high numbers of carbon atoms may reduce the cohesive strength and interface adhesive strength of the adhesive cured product due to the low Tg of their homopolymers, and thus the primary agent does not include a straight-chain or branched alkyl (meth)acrylate having five of more carbon atoms in some embodiments.

The primary agent (A) may also include other polymerizable monomers or oligomers as optional ingredients, such as vinyl acetate, vinyl chloride, vinyl fluoride, vinyl bromide, styrene, divinylbenzene, crotonate esters, maleate esters, styrenated unsaturated polyester resins, N,N-dimethyl acrylamide and N,N-diethyl acrylamide, N-t-butyl acrylamide, N-(acryloyl)morpholine, N-(acryloyl)piperidine, and other nitrogenous polymerizable monomers, as well as combinations thereof. These polymerizable monomers and oligomers can be used in amounts that will not remarkably affect the desired properties of the adhesive cured product.

In some embodiments, the primary agent (A) contains at least about 80% by mass, about 85% by mass, or about 90% by mass as a total of the isobornyl methacrylate constituting component (1) and the monocyclic methacrylate constituting component (2) in terms of the polymerizable component. In certain embodiments, the polymerizable component is constituted by the isobornyl methacrylate constituting component (1) and the monocyclic methacrylate constituting component (2).

The initiator (B) contains an organoborane. The organoborane initiates free radical polymerization of polymerizable monomers to form the polymers necessary for adhesive function. The organoborane can be represented by the following general formula:

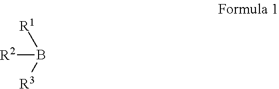

In the formula, R¹ is an alkyl group having 1 to about 10 carbon atoms, and R² and R³ may be identical or different, and are independently selected from alkyl groups having 1 to about 10 carbon atoms and aryl groups having 6 to 10 carbon atoms. Preferably, R¹, R², and R³ are independently selected from alkyl groups having 1 to about 5 carbon atoms. R¹, R², and R³ may be completely different, or two or more of R¹, R², and R³ may be identical, R¹, R², and R³, and a boron atom (B) to which these are bonded come together to form the initiator. Specific examples of organoboranes include trimethylborane, triethylborane, tri-n-propylborane, triisopropylborane, tri-n-butylborane, triisobutylborane, and tri-sec-butylborane.

The organoborane can be stabilized by using a complexing agent to form a complex. The organoborane complex can be represented by the following general formula:

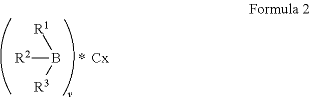

In the formula, R¹, R², and R³ are as described above, and Cx is the complexing agent.

Examples of useful complexing agents (Cx) include amine complexing agents, amidine complexing agents, hydroxide complexing agents, and alkoxide complexing agents. The ratio of boron atoms to the complexing agent (Cx) in the complex is represented by “v”, and is preferably selected so that an effective ratio of complexity agent to boron atoms is achieved. The ratio of boron atoms in the complex to complex formation sites of the complexing agent is preferably about 1:1. If the ratio of boron atoms to complex formation sites of the complexing agent exceeds that is, if the amount of boron atoms with respect to complex formation sites of the complexing agent is excessive, free organoboranes, which have a tendency to be naturally combustible, may be produced.

Various compounds having at least one amino group and mixtures thereof can be used as an amine complexing agent. The amine complexing agent may be a monoamine or a polyamine (namely, a compound having at least 2 amino groups, such as 2 to 4 amino groups). In a polyamine each of the plurality of amino groups is capable of functioning as a complex formation site, thus allowing two or more organoborane molecules to form complexes per one polyamine molecule.

In certain embodiments, the amine complexing agent is a primary or secondary monoamine. Examples of such monoamines include ammonia, ethylamine, butylamine, hexylamine, octylamine, benzylamine, morpholine, piperidine, pyrrolidine, and polyoxyalkylene monoamines (for example, JEFFAMINE® M715 and M2005 procurable from Huntsman PetroCheMical Corp., Houston, Tex.).

In other embodiments, the amine complexing agent is a polyamine. Examples of such polyamines include alkanediamines such as 1,2-ethanediamine, 1,3-propanediamine, 1,5-pentadiamine, 1,6-hexanediamine, 1,12-dodecanediamine, 2-methyl-1,5-pentanediamine, and 3-methyl-1,5-pentanediamine; alkylpolyamines such as triethylenetetramine and diethylenetriamine; polyoxyalkylene polyamines such as polyethylene oxide diamine, polypropylene oxide diamine, polypropyleneoxide triamine, diethylene glycol dipropylamine, triethylene glycol dipropylamine, polytetramethylene oxide diamine, poly(ethylene oxide-co-propylene oxide)diamine, and poly(ethylene oxide-co-propylene oxide)triamine; as well as isomers thereof.

The complexing agents disclosed, for example, in the pamphlet of International Publication 01/32717 can be used as an amidine complexing agent. Examples of such amidine complexing agents include N,N,N′N′-tetramethyl guanidine, 1,8-diazabicyclo[5.4.0]undeca-7-ene, 1,5-diazabicyclo[4.3.0]nona-5-ene, 2-methyl imidazole, 2-methyl imidazoline, and 4-(N,N-dimethylamino)pyridine.

The complexing agents disclosed, for example, in the pamphlet of International Publication 01/32716 can be used as hydroxide complexing agents and alkoxide complexing agents. Examples of such hydroxide complexing agents and alkoxide complexing agents include those represented by the general formula M^{m+}(R⁴O⁻)ₙ (wherein R⁴ is independently selected from hydrogen or organic groups (such as alkyl groups or alkylene groups), M^{m+} represents a countercation (such as a sodium ion, a potassium ion, a tetralkylammonium, or a combination thereof), m is an integer equal to 1 or greater, and n is an integer equal to 1 or greater).

The organoborane complex can easily be prepared using known techniques. Generally, the complexity agent will be stirred and mixed with the organoborane in an inert atmosphere. Because heat generation is often observed, it is desirable to chill the mixture and/or slowly add the organoborane to the complexing agent. If the component has a high vapor pressure, it is desirable to maintain a reaction temperature that is lower than about 70° C. to 80° C. After thoroughly mixing the materials, the complex is cooled to room temperature. Special storage conditions are not necessary, but the complex is preferably stored in a sealed container in a cool, dark place.

The organoborane is used in an amount effective for the polymerizable monomer of the primary agent to form a polymer of the desired degree of polymerization and the adhesive cured product to have the desired properties. If there is too little organoborane, polymerization may not progress completely, and as a result, the adhesive cured product may have insufficient adhesive properties. Conversely, if there is too much organoborane, polymerization may progress too rapidly, making it impossible to ensure an amount of usable time necessary to work with the adhesive, or reducing the degree of polymerization of the polymer so that the cohesive strength necessary for bonding cannot be obtained.

The amount of organoborane used will generally be at least about 0.003% by mass to no more than about 1.5% by mass, preferably at least about 0.008% by mass to no more than about 0.5% by mass, more preferably at least about 0.01% by mass to no more than about 0.3% by mass, in terms of boron with respect to the total mass of the adhesive (primary agent (A) and initiator (B)) less the mass of any fillers, non-reactive diluents, and other non-reactive materials. In the present disclosure, the term “non-reactive” as used in connection with the organoborane is used to refer to materials or components in which no extractable hydrogen atoms or unsaturated bonds are present. The percent by mass of the boron in the adhesive can be calculated according to the following formula:

$$\frac{\begin{matrix}( mass of organoborane within adhesive ) \times \\ ( \% by mass of boron in organoborane )\end{matrix}}{\begin{matrix}( total mass of adhesive not \\ including non \text{-} reactive components )\end{matrix}} \qquad Numerical Formula 1$$

The initiator (13) may contain a suitable diluent, such as an aziridine compound, or a combination thereof in order to dissolve or dilute the organoborane complex. Such diluents are disclosed, for example, in the pamphlet of International Publication 98/17694. The diluent is not reactive with respect to the organoborane or the organoborane complex, and functions as an extender for the organoborane or organoborane complex.

The carbon atoms of the aziridine compound used as a diluent include at least one aziridine ring or group that may optionally be substituted by any short chain alkyl group (such as organic groups having 1 to about 10 carbon atoms, preferably methyl, ethyl, or propyl) so as to form, for example, a methyl, ethyl, or propyl aziridine moiety. In some embodiments, the aziridine compound is polyaziridine.

Examples of useful commercially available polyaziridine are Crosslinker® CX-100 (obtainable from DSM NeoResins, Wilmington, Mass.), and the like.

The aziridine compound is advantageously soluble in the organoborane complex; and using such an aziridine compound allows a two-pack adhesive of superior storability to be provided. The aziridine compound is advantageous in that it is soluble in the monomer contained in the primary agent; using such an aziridine compound allows a homogeneous mixture to be easily formed, and the ease of use of the adhesive to be improved. The amount of aziridine compound used will generally be no more than about 50% by mass, preferably about 25% by mass or less, and more preferably about 10% by mass or less, with respect to the total mass of the adhesive. The organoborane complex may be dissolved in the aziridine compound in a suitable amount (such as about 75% by mass or more, up to about 100% by mass).

If an organoborane complex is included in the initiator, the primary agent (A) will further contain a decomplexing agent. In the present disclosure, the term “decomplexing agent” means a compound that is capable of releasing the organoborane from the complexing agent by reacting, for example, with the amino groups, amidine groups, hydroxide groups, or alkoxide groups in the complexing agent. The decomplexing agent allows the polymerizable monomer contained in the primary agent to begin reacting.

If the organoborane forms a complex with an amine complexing agent, a preferred decomplexing agent is an amine-reactive compound. Examples of typical useful amine-reactive compounds include acids, acid anhydrides, aldehydes, and beta-ketone compounds. Isocyanates, acid chlorides, sulfonyl chlorides, and the like, such as isophorone diisocyanate, toluene diisocyanate, and methacryloyl chloride, can also be used as the amine-reactive compound.

Examples of useful acids include Lewis acids (such as SnCl₄ and TiCl₄) and Brønsted acids (such as aliphatic carboxylic acids having straight-chain or branched saturated or unsaturated alkyl groups with 1 to about 8 carbon atoms, or aromatic carboxylic acids having an aromatic ring with 6 to 10 substituted or unsubstituted carbon atoms, such as acrylic acid, methacrylic acid, acetate, benzoic acid, and p-methoxy benzoic acid, hydrochloric acid, sulfuric acid, phosphoric acid, phosphonic acid, phosphinic acid, silicic acid, and the like). Dicarboxylic acids such as oxalic acid, malonic acid, succinic acid, glutaric acid, adipic acid, maleic acid, fumaric acid, phthalic acid, isophthalic acid, and terephthalic acid, or carboxylic acid esters such as 1,2-ethylene bis maleate, 1,2-propylene bis maleate, 2,2′-diethylene glycol bis maleate, 2,2′-dipropylene glycol bis maleate, and trimethylol propane trimaleate can also be used.

A chained or cyclic acid anhydride can also be used as an amine-reactive compound. If a free radical polymerizable group such as an ethylenically unsaturated group is present in the acid anhydride, copolymerization with the polymerizable monomer contained in the primary agent may be possible. Examples of useful acid anhydrides include acetic anhydride, propionic anhydride, succinic anhydride, maleic anhydride, phthalic anhydride, and the like.

Examples of useful aldehydes include benzaldehyde, o-, m-, and p-nitrobenzaldehyde, 2,4-dichlorobenzaldehyde, p-tolualdehyde, 3-methoxy-4-hydroxybenzaldehyde and the like. Aldehydes that have been blocked using an acetal or the like can also be used.

The compounds disclosed, for example, in the pamphlet of International Publication 2003/057743 can be used as useful beta-ketone compounds. Methyl acetoacetate, ethyl acetoacetate, t-butyl acetoacetate, 2-methacryloyloxyethyl acetoacetate, diethylene glycol bis(acetoacetate), polycaprolactone tris(acetoacetate), propylene glycol bis(acetoacetate), poly(styrene-co-allyl acetoacetate), N,N-dimethyl acetoacetamide, N-methyl acetoacetamide, acetoacetanilide, ethylene bis(acetoacetamide), propylene glycol bis(acetoacetamide), acetoacetamide, acetoacetonitrile, and the like can be used as such beta-ketone compounds.

The decomplexing agent is used in an effective amount, namely, an amount that is effective for releasing the organoborane from the complexing agent and promoting polymerization while not substantially affecting the desired properties of the adhesive cured product. It will be apparent to a person skilled in the art that if there is too much decomplexing agent, polymerization may progress too rapidly, making it impossible to ensure an amount of usable time necessary to work with the adhesive, or reducing the degree of polymerization of the polymer so that the cohesive strength necessary for bonding cannot be obtained. Conversely, if too little decomplexing agent is used, polymerization may not progress completely, and as a result, the adhesive cured product may have insufficient adhesive properties. The decomplexing agent will generally be used in an amount such that the molar ratio of the amine-reactive group, amidine-reactive group, hydroxide-reactive group, or alkoxide-reactive group in the decomplexing agent to the amino group, amidine group, hydroxide group, or alkoxide group in the complexing agent is in a range from 0.1:1.0 to 10.0:1.0, and preferably such that the molar ratio of the amine-reactive group, amidine-reactive group, hydroxide-reactive group, or alkoxide-reactive group in the decomplexing agent to the amino group, amidine group, hydroxide group, or alkoxide group in the complexing agent is in a range from 0.2:1.0 to 4.0:1.0, or is about 1.0:1.0.

The primary agent (A) and/or initiator (B) may optionally contain at least one type of metal salt capable of adjusting the curing kinetics of the adhesive to provide a favorable balance between usable time and polymerization speed.

Examples of metal cations of metal salts include cations of vanadium, chromium, manganese, iron, cobalt, nickel, copper, molybdenum, ruthenium, rhodium, palladium, antimony, platinum, and cerium. Of these metal cations, cations of vanadium, chromium, manganese, iron, cobalt, nickel, copper, ruthenium, palladium, and antimony are preferable, with cations of manganese, iron, cobalt, and copper being more preferable for the sake of reduced cost, increased activity, and satisfactory hydrolytic stability, and cations of copper and iron are even more preferable. The metal cation may optionally include a sigma electron-donating ligand such as water, ammonia, or an amine, or a pi electron-donating ligand such as a carbonyl (carbon monoxide), an isonitrile, a phosphine, a phosphite, an arsine, a nitrosyl (nitrogen oxide), ethylene, or the like.

Examples of metal salt counterions (anions) include halide ion, borate ions, sulfonate ions, and carboxylate ions, with chloride ions, bromide ions, tetrafluoroborate ions, trifluoromethane sulfonate ions, naphthenate ions, and 2-ethylhexanoate ions being preferable.

Examples of preferable metal salts include copper (II) bromide, copper (II) chloride, copper (II) 2-ethylhexanoate, iron (III) bromide, vanadium (III) bromide, chromium (III) bromide, ruthenium (III) bromide, copper (II) tetrafluoroborate, copper (II) trifluoromethane sulfonate, copper (II) napthenate, copper (I) bromide, iron (II) bromide, manganese (II) bromide, cobalt (II) bromide, nickel (II) bromide, antimony (III) bromide, and palladium (II) bromide.

The metal salt is used in an effective amount, namely, an amount that will affect the curing kinetics of the adhesive while not substantially affecting the desired properties of the adhesive cured product. The amount of metal salt will generally be at most about 40,000 ppm, preferably at least about 60 ppm to no more than about 20,000 ppm, more preferably at least about 100 ppm to no more than about 4,000 ppm, with respect to the total mass of the adhesive. The metal salt is advantageously dissolvable in the primary agent, or else at least partially dissolves in the adhesive while in use.

The two-pack adhesive of the present disclosure may further contain an optional additive. Such additives will generally be added to the primary agent (A), but can also be added to the initiator (B) to the extent that the function of the initiator is not negatively affected.

One useful additive is a thickening agent such as polybutyl methacrylate having a molecular weight of about 10,000 to about 40,000. Using a thickening agent allows the viscosity of the adhesive to be increased to a syrupy consistency allowing for more superior ease of application. Such a thickening agent can generally be used in an amount equal to no more than about 50% by mass per the total mass of the adhesive.

Another useful additive is an elastomeric material. An elastomeric material is capable of improving the fracture toughness of the cured adhesive. This can be useful when bonding, for example, rigid high-yield-strength materials (such as metal substrates that do not mechanically absorb energy as easily as other materials such as flexible polymer substrates). Such an additive can generally be used in an amount equal to no more than about 50% by mass of the total mass of the adhesive.

A core-shell polymer can also be used to improve the case of application and flow properties of the adhesive. Improved ease of application and flow properties can be confirmed via reductions in undesirable strings left when the adhesive is distributed using a syringe-type applicator and sagging after the adhesive has been applied to a vertical surface. A core-shell polymer can generally be added in an amount equal to at least about 5% by mass, about 10% by mass, or about 20% by mass to no more than about 50% by mass, about 40% by mass, or about 30% by mass with respect to the total mass of the adhesive.

A reactive diluent may be added to the primary agent (A) and/or the initiator (B). Examples of preferable reactive diluents include the 1,4-dioxo-2-butene functional compounds disclosed in the specification of U.S. Pat. No. 6,252,023 and aziridine compounds such as those disclosed in the specification of U.S. Pat. No. 5,935,711.

A vinyl aromatic compound such as disclosed in the pamphlet of International Publication No. 01/68783 can also be added to the initiator (B) and/or the primary agent (A) to increase the usable time of the adhesive without substantially affecting polymerization speed, curing time, and the desired properties of the cured adhesive.

An example of a useful vinyl aromatic compound is an alpha-methylstyrene group-containing oligomer prepared by reacting 3-isopropenyl-α,α-dimethylbenzyl isocyanate (obtainable from Cytec Industries, Inc., Woodland Park, N.J. under the trade name “TMI”) with a monofunctional or polyfunctional reactive hydrogenated compound, preferably a monofunctional or polyfunctional amine, alcohol, or combination thereof. Examples of especially preferred monofunctional and polyfunctional amines include amine-terminated polyethers sold under the trade name JEFFAMINE, such as JEFFAMINE ED600 (diamine-terminated polyether having a nominal molecular weight of 600), JEFFAMINE D400 (diamine-terminated polyether having a nominal molecular weight of 400), JEFFAMINE D2000 (diamine-terminated polyether having a nominal molecular weight of 2,000), JEFFAMINE T3000 (triamine-terminated polyether having a normal molecular weight of 3,000), and JEFFAMINE M2005 (monoamine-terminated polyether having a nominal molecular weight of 2,000), all obtainable from Huntsman PetroChemical Corp., Houston, Tex. Examples of preferable alcohol-containing compounds include polypropylene glycol, polycaprolactone triol, and diethylene glycol. The vinyl aromatic compound can generally be added in an amount equal to at least about 1% by mass, about 2% by mass, or about 5% by mass to no more than about 30% by mass, about 20% by mass, or about 10% by mass with respect to the total mass of the adhesive.

Small amounts of an inhibitor such as a hydroquinone monornethyl ether or a tris(N-nitroso-N-phenylhydroxylamine) aluminum salt can be added to the primary agent (A) to prevent or reduce, for example, degradation of the polymerizable monomer during storage. The inhibitor can be added in an amount that will not essentially reduce the polymerization speed of the monomer or the desired properties of the adhesive cured product. The inhibitor can generally be used in an amount equal to at least about 100 ppm to no more than about 10,000 ppm with respect to the polymerizable component.

Examples of other optional additives include non-reactive diluents and solvents (such as acetone, methyl ethyl ketone, ethyl acetate, N-methyl caprolactam, and the like), non-reactive coloring agents, fillers (such as carbon black, hollow glass/ceramic beads, silica, titanium dioxide, solid glass/ceramic microspheres, silica-alumina ceramic microspheres, electrically conductive and/or thermally conductive particles, antistatic compounds, chalk, and the like), and the like. These various optional additives can be added in an amount that will not essentially reduce the polymerization speed of the monomer or the desired properties of the adhesive cured product.

The two-pack adhesive of the present disclosure is especially useful when bonding a low surface energy plastic or polymer substrate, which are adhesive-resistant materials, without using complicated surface treatment techniques such as flame treatment, ITRO treatment, corona discharge, or primer treatment. In the present disclosure, the term “low surface energy” is used in reference to materials having a surface energy of less than 45 mJ/m², more typically less than 40 mJ/m² or less than 35 mJ/m². Examples of such materials include olefin-based materials such as polyethylene (PE) and polypropylene (PP), acrylonitrile-butadiene-styrene (ABS), fluorinated polymers having a surface energy of less than 20 mJ/m² such as polytetrafluoroethylene (PTFE), elastomer-modified versions of these materials, and polymer blends of these materials with ethylene-propylene rubber (EPM), ethylene-propylene-diene rubber (EPDM), and other elastomers. Examples of other polymers of comparative high surface energy that can be practically used in the two-pack adhesive of the present disclosure include polycarbonate (PC), polymethylmethacrylate (PMMA), and polyvinyl chloride (PVC). The two-pack adhesive of the present disclosure can be advantageously used in substrates containing readily oxygen-adsorbing elastomer-modified materials or elastomer polymer blends. Examples of preferable substrates containing elastomer-modified materials and elastomer polymer blends include elastomer-modified polyolefins such as polyethylene and polypropylene, and olefin-based elastomer substrates containing polymer blends of polyethylene, polypropylene, or the like with elastomers such as ethylene-propylene rubber (EPM) or ethylene-propylene-diene rubber (EPDM), especially polypropylene-based elastomer substrates containing elastomer-modified polypropylene and polymer blends of elastomers such as ethylene-propylene rubber (EPM) or ethylene-propylene-diene rubber (EPDM) with polypropylene.

The primary agent (A) and the initiator (B) of the two-pack adhesive of the present disclosure are mixed as is normal when handling such materials. The two-pack adhesive of the present disclosure may be partially or entirely mixed before the adhesive is applied to a substrate.

When using the two-pack adhesive in a commercial or industrial environment, it is advantageous for the mixing proportions of the primary agent (A) and the initiator (B) to be simple integers in order to facilitate application of the adhesive using a conventional commercially available feeder device. A double-syringe applicator such as disclosed in the specifications of U.S. Pat. Nos. 4,538,920 and 5,082,147, for example, a MIXPAC™ mixer (obtainable from ConProTec, Inc., Salem, N.H.), can be used as a feeder device of this sort.

Ordinarily, the feeder device will be equipped with a set of tubular containers disposed next to each other, designed so that each tube carries either the primary agent or the initiator of the adhesive. Two plungers, one provided on each tube, are simultaneously moved (for example, manually or using a manually operated gear mechanism) to deliver the contents of the tubes into a shared elongated mixing chamber. The mixing chamber may be equipped with a static mixer in order to promote the mixing of the two liquids. The mixed adhesive is fed from the mixing chamber onto a substrate. When the tubes become empty, they can be replaced with new tubes to continue the application process.

The proportions at which the primary agent and the initiator of the adhesive are mixed can be adjusted via the diameters of the tubes. In such cases, each of the plungers has a dimension of a fixed diameter adapted to the interior of the respective tube, and the plungers move within the tubes at the same speed. The feeder device is often intended for use with various different types of two-pack adhesives, and the plungers have dimensions such that the primary agent and the initiator of the adhesive are mixed at a preferable mixing ratio. In some embodiments, the mixing ratio of the primary agent and the initiator is generally 1:1, 2:1, 4:1, or 10:1.

If the primary agent and the initiator of the adhesive are mixed in a fractional mixing ratio (such as 100:3.5), the user will have to manually weigh the two liquids of the adhesive. Thus, it is advantageous for the two liquids of the adhesive to be mixable at a typical integer mixing ratio such as 10:1 or less, more preferably 4:1, 3:1, 2:1, or 1:1, in order to increase the commercial and industrial usefulness of the adhesive and facilitate the use of currently usable feeder devices. In order to adjust the mixing ratio of the two liquids of the adhesive to an integer mixing ratio (such as 10:1, 4:1., 3:1, 2:1, or 1:1), a vinyl aromatic compound as already described can be advantageously added to the initiator.

After the two liquids have been mixed, the adhesive is preferably used within a usable time of the adhesive. The adhesive is applied to one or both substrates, followed by pressure being applied to the substrates to bond the substrates to each other and extrude excess adhesive from the bond line. Such an arrangement also allows for the removal of adhesive exposed to the air that might cure too quickly. Generally, bonding is preferably performed within a short amount of time after the adhesive has been applied to the substrate, and within the usable time of the adhesive. The thickness of the adhesive layer will generally be at least about 0.01 mm to no more than about 0.3 mm, but may exceed 1.0 mm if there is a need to fill gaps between the substrates. The bonding process can easily be performed at room temperature, and the adhesive can be post-cured at high temperature as necessary.

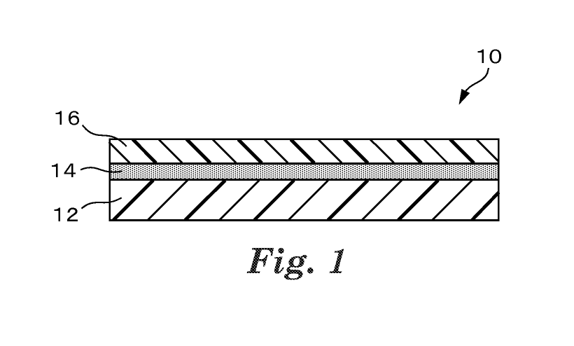

One example of an embodiment using the two-pack adhesive of the present disclosure is a structural piece 10 including a first olefin-based elastomer substrate 12, a second olefin-based elastomer substrate 16, and a cured product 14 of the two-pack adhesive that is disposed between the first olefin-based elastomer substrate 12 and the second olefin-based elastomer substrate 16 and bonds the first olefin-based elastomer substrate 12 and the second olefin-based elastomer substrate 16, as shown in FIG. 1.

### EXAMPLES

In the following examples, specific examples of the present disclosure are illustrated, but the present invention is not restricted thereto. All parts and percentages are by mass unless otherwise indicated.

### Adhesive Evaluation Method

### (1) Test of Shear Strength Following Curing at 35° C. (OLS(35CCure))

A piece of non-surface treated elastomer-modified polypropylene TSOP-GP6B (Toyota Tsusho) or polypropylene natural PP-N-BN (Kobe Polysheet™, Shin-Kobe Electric Machinery) cut to 2.5 cm×10 cm×0.3 cm was used as a test strip for a shear strength test. After the mixed two-pack adhesive was applied to one test strip, another test strip was immediately laid thereupon to sandwich the adhesive, and the two test strips were fixed in place with clips while adjusting the position so that the area coated by the adhesive was 1 cm×2.5 cm. The clipped test strips were cured at 35° C. for one day, after which the clips were removed. The cured bonding test strips were drawn in a shear direction at a temperature of 23° C. and a rate of 5 cm/minute using an RTC-1325 A tensile tester (A&D), maximum shear strength was measured in terms of MPa, and the test strips were visually observed after breaking to confirm the failure mode.

### (2) Hot Water Resistance Test (OLS(70CW1681))

Bonding test strips prepared according to a method similar to that used for test (1) were submerged in 70° C. hot water for 168 hours, then removed and allowed to stand at 23° C. for one hour, after which the shear strength was measured in a manner similar to test (1), and the failure mode was confirmed via visual observation.

### EXAMPLES 1-5 AND COMPARATIVE EXAMPLES 1-11

### Alpha-methylstyrene Group-Containing Oligomer Synthesis (AMSPU2400)

An amount of 120.60 g of TMI (3-isopropenyl-α,α-dimethylbenzyl isocyanate; Cytec Industries, Inc.) and 600.00 g of JEFFAMINE D2000 (diamine-terminated polypropylene glycol, nominal molecular weight: 2000; Huntsman Petrochemical Corp.) were mixed and allowed to react overnight at room temperature without adjusting the temperature. IR spectrum determination results showed that the isocyanate peak vanished at a frequency of 2,265 cm⁻¹, thereby confirming that the reaction was complete. In this manner, an alpha-methylstyrene group-containing oligomer (AMSPU2400) was obtained.

### Initiator (B)

An amount of 11.87 g of a triethyl borane/1,6-hexanediamine complex having a molar ratio of 2:1 was dissolved in 22.03 g of CX-100 (trimethylol propane tris(3-(2-methylaziridine))propionate; DSM NeoResins). Next, 62.30 g of AMSPU2400, 3.60 g of Cab-O-Sil TS-720 (silane-modified fumed silica; Cabot Corp.), and 0.20 g of XC-72 (carbon black; Cabot Corp.) were mixed, then degassed in vacuo until no more gas bubbles were produced. The obtained initiator was used in all of Examples 1-5 and Comparative Examples 1-11.

### Primary Agent (A)

The materials used as primary agents are shown in Table 1. The compositions of the primary agents of Examples 1 to 5 and Comparative Examples 1 to 11 are shown in Table 2. The various components were weighed into a 200 mL glass bottle so that the total mass of the primary agent was 100 g and were then left standing at 60° C. for 30 minutes, followed by being stirred for two minutes at 2,000 rpm using an “Awatori Rentaro” ARE-500 (rotating/revolving mixer; Thinky Corp).

TABLE 1

| Trade name or | | |
|---|---|---|
| abbreviation | Description | Supplier |
| IBXMA | Isobornyl methacrylate | Mitsubishi Rayon |
| PhEMA | Phenoxyethyl methacrylate | Sartomer Company |
| THFMA | Tetrahydrofurfuryl | Mitsubishi Rayon |
| | methacrylate | |
| CHMA | Cyclohexyl methacrylate | Mitsubishi Rayon |
| IBXA | Isobornyl acrylate | Kyoeisha Chemical |
| HEMA | Hydroxyethyl methacrylate | Mitsubishi Rayon |
| BZMA | Benzyl methacrylate | Mitsubishi Rayon |
| BZA | Benzyl acrylate | Osaka Organic |
| | | Chemical Industry |
| SA | Succinic anhydride | DSM |
| CuBr | Copper (II) bromide | Nihon Kagaku |
| | | Sangyo |
| NMC | N-methyl caprolactam | Wako Pure Chemical |
| | | Industries |
| Kaneace ™ B564 | Core-shell polymer | Kaneka |
| Zefiac ™ F351 | Core-shell polymer | Zeon Kasei |
| E-sphere SL300 | Silica alumina ceramic | Envirospheres |
| | microspheres | |
| CN965 | Aliphatic polyester-based | Sartomer Company |
| | urethane acrylate | |
| TiO₂ CR60 | Titanium dioxide | Ishihara Sangyo |

TABLE 2

| | | | | | | Comparative | Comparative | Comparative |
|---|---|---|---|---|---|---|---|---|
| | Example 1 | Example 2 | Example 3 | Example 4 | Example 5 | Example 1 | Example 2 | Example 3 |
| IBXMA | 45.76 | 36.61 | 27.46 | 36.61 | 36.61 | 73.22 | 54.92 | 18.31 |
| PhEMA | 27.46 | 36.61 | 45.76 | | | | 18.31 | 54.92 |
| THFMA | | | | 36.61 | | | | |
| CHMA | | | | | 36.61 | | | |
| IBXA | | | | | | | | |
| HEMA | | | | | | | | |
| BZMA | | | | | | | | |
| BZA | | | | | | | | |
| SA | 0.62 | 0.62 | 0.62 | 0.62 | 0.62 | 0.62 | 0.62 | 0.62 |
| CuBr | 0.20 | 0.20 | 0.20 | 0.20 | 0.20 | 0.20 | 0.20 | 0.20 |
| NMC | 0.60 | 0.60 | 0.60 | 0.60 | 0.60 | 0.60 | 0.60 | 0.60 |
| B564 | 15.00 | 15.00 | 15.00 | 15.00 | 15.00 | 15.00 | 15.00 | 15.00 |
| F351 | 5.00 | 5.00 | 5.00 | 5.00 | 5.00 | 5.00 | 5.00 | 5.00 |
| SL300 | 1.98 | 1.98 | 1.98 | 1.98 | 1.98 | 1.98 | 1.98 | 1.98 |
| CN965 | 2.37 | 2.37 | 2.37 | 2.37 | 2.37 | 2.37 | 2.37 | 2.37 |
| CR60 | 1.00 | 1.00 | 1.00 | 1.00 | 1.00 | 1.00 | 1.00 | 1.00 |
| Total | 100.0 | 100.0 | 100.0 | 100.0 | 100.0 | 100.0 | 100.0 | 100.0 |

| | Comparative | Comparative | Comparative | Comparative | Comparative | Comparative | Comparative | Comparative |
|---|---|---|---|---|---|---|---|---|
| | Example 4 | Example 5 | Example 6 | Example 7 | Example 8 | Example 9 | Example 10 | Example 11 |
| IBXMA | 9.15 | | | 36.61 | 36.61 | 36.61 | | |
| PhEMA | 64.07 | 73.22 | 36.61 | | | | | |
| THFMA | | | | | | | 73.22 | |
| CHMA | | | | | | | | 73.22 |
| IBXA | | | 36.61 | | | | | |
| HEMA | | | | 36.61 | | | | |
| BZMA | | | | | 36.61 | | | |
| BZA | | | | | | 36.61 | | |
| SA | 0.62 | 0.62 | 0.62 | 0.62 | 0.62 | 0.62 | 0.62 | 0.62 |
| CuBr | 0.20 | 0.20 | 0.20 | 0.20 | 0.20 | 0.20 | 0.20 | 0.20 |
| NMC | 0.60 | 0.60 | 0.60 | 0.60 | 0.60 | 0.60 | 0.60 | 0.60 |
| B564 | 15.00 | 15.00 | 15.00 | 15.00 | 15.00 | 15.00 | 15.00 | 15.00 |
| F351 | 5.00 | 5.00 | 5.00 | 5.00 | 5.00 | 5.00 | 5.00 | 5.00 |
| SL300 | 1.98 | 1.98 | 1.98 | 1.98 | 1.98 | 1.98 | 1.98 | 1.98 |
| CN965 | 2.37 | 2.37 | 2.37 | 2.37 | 2.37 | 2.37 | 2.37 | 2.37 |
| CR60 | 1.00 | 1.00 | 1.00 | 1.00 | 1.00 | 1.00 | 1.00 | 1.00 |
| Total | 100.0 | 100.0 | 100.0 | 100.0 | 100.0 | 100.0 | 100.0 | 100.0 |

### Adhesive

The volume ratio 1 side of a dual-syringe applicator having a 10:1 volume ratio (MIXPAC CD050-10-PP; ADY Inc.) was filled with the initiator, and the volume ratio 10 side was filled with the primary agent, after which the applicator was fitted with a 10 cm-long 17-stage static mixer nozzle (MX5.4-17S; ADY Inc.), and the primary agent and initiator were simultaneously extruded to apply the adhesive, which was mixed in the static mixer nozzle. The results of the evaluation of the cured adhesive in the shear strength test (OLS(35CCure)) and the hot water resistance test (OLS(70CW168h)) after curing at 35° C. are shown in Table 3.

TABLE 3

| | TSOP | | PP |
|---|---|---|---|
| | OLS(35CCure) | OLS(70CW168h) | OLS(35CCure) |
| | (MPa/failure mode) | (MPa/failure mode) | (MPa/failure mode) |
| Example 1 | 4.79/material failure | 4.56/material failure | |
| Example 2 | 4.88/material failure | 4.57/material failure | 3.45/mixture of cohesive failure and interface failure |
| Example 3 | 4.81/material failure | 4.65/material failure | |
| Example 4 | 4.76/material failure | 4.66/material failure | 3.41/mixture of cohesive failure and interface failure |
| Example 5 | 4.75/material failure | 4.95/material failure | 2.68/mixture of cohesive failure and interface failure |
| Comparative Example 1 | 2.41/cohesive failure | | 0.96/interface failure |
| Comparative Example 2 | 2.94/cohesive failure | | |
| Comparative Example 3 | 4.05/interface failure | | |
| Comparative Example 4 | 3.79/interface failure | | |
| Comparative Example 5 | 0.68/interface failure | | 4.24/mixture of cohesive failure and interface failure |
| Comparative Example 6 | 3.66/interface failure | | 10.90/cohesive failure |
| Comparative example 7 | 5.04/interface failure | 3.37/interface failure | |
| Comparative Example 8 | 1.80/interface failure | | 3.65/mixture of cohesive failure and interface failure |
| Comparative Example 9 | 1.29/interface failure | | |
| Comparative Example 10 | 0.52/interface failure | | |
| Comparative Example 11 | 0.43/interface failure | | |

As shown in Table 3, it is apparent that after being cured at 35° C. for one day, all of the bonding test strips of Examples 1 to 5 exhibited material failure, and the cured adhesives had a shear strength of at least 4.5 MPa. It is also apparent that the bonding test strips of Examples 1 to 5 also had a shear strength of at least 4.5 MPa after the hot water resistance test in which they were left standing in 70° C. hot water for 168 hours (one week). The adhesives of Examples 1 to 5 exhibited good adhesive strength on elastomer-modified polypropylene even when cured at the comparatively high temperature of 35° C. and had high hot water resistance.

1. A two-part adhesive comprising:
(A) a primary agent comprising isobornyl methacrylate and phenoxyethyl methacrylate tetrahydrofurfuryl methacrylate, and cyclohexyl methacrylate; and
(B) an initiator comprising an organoborane,
wherein the adhesive containing from 40 to 200 parts by mass of the phenoxyethyl methacrylate per 100 parts by mass of the isobornyl methacrylate.

2. The two-part adhesive according to claim 1, wherein the primary agent comprises at least 25% by mass of the isobornyl methacrylate with respect to polymerizable components.

3. (canceled)

4. The two-part adhesive according to any one of claim 1, wherein the primary agent comprises a total of at least 80% by mass of the isobornyl methacrylate and the phenoxyethyl methacrylate with respect to polymerizable components.

5. The two-part adhesive according to any one of claim 1, wherein the primary agent does not contain a straight-chain or branched alkyl (meth)acrylate having five or more carbon atoms.

6. The two-part adhesive according to claim 1, bonded to an olefin elastomer substrate.

7. A structural piece comprising:
a first olefin elastomer substrate;
a second olefin elastomer substrate; and
a cured product of the two-part adhesive according to any one of claim 1 disposed between the first olefin elastomer substrate and the second olefin elastomer substrate and bonding the first olefin elastomer substrate and the second olefin elastomer substrate.

8. The two-part adhesive according to claim 2, wherein the primary agent comprises a total of at least 80% by mass of the isobornyl methacrylate and the phenoxyethyl methacrylate with respect to polymerizable components.

9. The two-part adhesive according to claim 2, wherein the primary agent does not contain a straight-chain or branched alkyl (meth)acrylate having five or more carbon atoms.

10. The two-part adhesive according to claim 4, wherein the primary agent does not contain a straight-chain or branched alkyl (meth)acrylate having five or more carbon atoms.

11. The two-part adhesive according to claim 8, wherein the primary agent does not contain a straight-chain or branched alkyl (meth)acrylate having five or more carbon atoms.

12. The two-part adhesive according to claim 2 bonded to an olefin elastomer substrate.

13. The two-part adhesive according to claim 4 bonded to an olefin elastomer substrate.

14. The two-part adhesive according to claim 5 bonded to an olefin elastomer substrate.

15. A structural piece comprising:
a first olefin elastomer substrate;
a second olefin elastomer substrate; and
a cured product of the two-part adhesive according to claim 2 disposed between the first olefin elastomer substrate and the second olefin elastomer substrate and bonding the first olefin elastomer substrate and the second olefin elastomer substrate.

16. A structural piece comprising:
a first olefin elastomer substrate;
a second olefin elastomer substrate; and
a cured product of the two-part adhesive according to claim 4 disposed between the first olefin elastomer substrate and the second olefin elastomer substrate and bonding the first olefin elastomer substrate and the second olefin elastomer substrate.

17. A structural piece comprising:
a first olefin elastomer substrate;
a second olefin elastomer substrate; and
a cured product of the two-part adhesive according to claim 5 disposed between the first olefin elastomer substrate and the second olefin elastomer substrate and bonding the first olefin elastomer substrate and the second olefin elastomer substrate.

18. A structural piece comprising:
a first olefin elastomer substrate;
a second olefin elastomer substrate; and
a cured product of the two-part adhesive according to claim 8 disposed between the first olefin elastomer substrate and the second olefin elastomer substrate and bonding the first olefin elastomer substrate and the second olefin elastomer substrate.

19. A structural piece comprising:
a first olefin elastomer substrate;
a second olefin elastomer substrate; and
a cured product of the two-part adhesive according to claim 9 disposed between the first olefin elastomer substrate and the second olefin elastomer substrate and bonding the first olefin elastomer substrate and the second olefin elastomer substrate.

20. A structural piece comprising:
a first olefin elastomer substrate;
a second olefin elastomer substrate; and
a cured product of the two-part adhesive according to claim 10 disposed between the first olefin elastomer substrate and the second olefin elastomer substrate and bonding the first olefin elastomer substrate and the second olefin elastomer substrate.

21. A structural piece comprising:
a first olefin elastomer substrate;
a second olefin elastomer substrate; and
a cured product of the two-part adhesive according to claim 11 disposed between the first olefin elastomer substrate and the second olefin elastomer substrate and bonding the first olefin elastomer substrate and the second olefin elastomer substrate.
